(19) United States
(12) Patent Application Publication
(10) Pub. No.: US 2006/0230434 A1
(43) Pub. Date: Oct. 12, 2006

(54) Security information notification system and notification method, and control unit for security information notification system

(75) Inventor: Osami Sunagawa, Toyonaka City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/386,695

(22) Filed: Mar. 23, 2006

(30) Foreign Application Priority Data
Mar. 28, 2005 (JP) 2005-090501

(51) Int. Cl. H04L 9/32; G06F 15/16; G06F 17/30; G06F 7/04

(52) U.S. Cl. 726/3

(57) ABSTRACT

Security information notification system furnished with sensor for detecting occurrence of an abnormality, and a control unit that receives an abnormality detection signal from the sensor and issues first alarm information to a user, and then, after a set period has elapsed since issuing the first alarm information, issues second alarm information that is more detailed than the first alarm information to the user. The control unit has a transmission interrupt function that by user operation within the set period stops issuance of the second alarm information.

### BACKGROUND OF THE INVENTION

1. Field of the Invention

The present invention relates to security information notification systems and notification methods, and control units for such security information notification systems, for transmitting security information that has been detected by a camera or a sensor within a building, such as a residence, to a portable terminal of a user in a remote location.

2. Description of the Related Art

Criminal acts such as burglaries have been on the rise at personal residences, etc. in recent years, and this has led to proposals for security information notification systems that allow a user in a remote location to learn of the conditions within his or her residence in real time. FIG. 10 is a block diagram of a security information notification system that has been proposed in the past. Within a building 2, such as a residence, are provided a surveillance camera 10, a sensor 11 for detecting the temperature changes found in people and animals, a sensing circuit (not shown) for detecting movement from changes on a screen, and a control unit 1 that is connected to the surveillance camera 10, the sensor 11, and the sensing circuit, and also is connected to a portable systems network 30 of a portable telephone 3 via a telephone line 4. The telephone line 4 is connected to the Internet 6 and the portable systems network 30 through a provider 40, a company for providing this connection.

When the sensor 11 and the sensing circuit have detected that there is an intruder based on temperature changes within the area under detection and changes on the screen, the surveillance camera 10 records an image of the area under video surveillance. The control unit 1 transmits voice information indicating that there is an intruder to the user's portable telephone 3 over the telephone line 4 and the portable systems network 30.

The control unit 1 digitizes the images that have been captured by the surveillance camera 10 and compresses the data and sends it to the provider 40 over the telephone line 4. The provider 40 sends those transmitted camera images to the portable telephone 3 via the portable systems network 30. The user can use a personal computer 60 to view the conditions within the residence from a web page on the Internet 6. The control unit 1 also can transmit an electronic mail message indicating that an intruder is present in lieu of, or together with, the images that have been captured by the surveillance camera 10. Thus, the systems that conventionally have been proposed have an abnormality notification function for notifying a user in a remote location that an abnormality has occurred within the building 2.

With this system, the sensor 11 and the surveillance camera 10 are activated also when the user returns home and enters the region sensed by the sensor 11, and transmit image information, etc. to the portable telephone 3, and this becomes an annoyance. Thus, some systems allow a mode for delaying transmission of the image information, etc. to be set through the control unit 1. In this transmission delay mode, if the user has set the delay time to one minute, for example, then the image information, etc. will be sent to the portable telephone 3 after one minute has elapsed from when the user enters the region that is sensed by the sensor 11. When the user performs an operation to indicate that transmission is not necessary within one minute of entering the region that is sensed by the sensor 11, the image information, etc. is not transmitted to the portable telephone 3.

However, the above security information notification system has the following problems.

If an intruder knows how to operate the control unit 1, then when the above transmission delay mode has been set, the intruder can perform an operation within the delay time to indicate that transmission is not necessary, in which case the user will not be notified that an intruder is present. In this case, even though an abnormality notification function exists, it may not be useful.

Further, with this system it takes approximately 10 seconds for an electronic mail, etc. to be transmitted to the portable telephone 3 after the sensor 11 has detected that an intruder is present. During this time the intruder may notice the surveillance camera 10 and for example destroy the surveillance camera 10, and in this case the user will not be notified that there is an intruder, and in this regard as well, there is a possibility that even though an abnormality notification function exists, it may not be useful.

### SUMMARY OF THE INVENTION

According to the preferred embodiments, system and method are provided, which can reliably notify a user of at least the fact that an abnormality has occurred.

One implementation of the invention includes sensor for detecting occurrence of an abnormality, and a control unit 1 that receives an abnormality detection signal from the sensor and issues first alarm information to a user, and then, after a set period has elapsed since issuing the first alarm information, issues second alarm information that is more detailed than the first alarm information, wherein the control unit 1 has a transmission interrupt function that allows the user to perform an operation within the set period to stop issuance of the second alarm information.

It is also possible to provide a server that is arranged between the control unit 1 and a alerting device in the possession of the user, and that can hold the first alarm information for a grace period. The server has a hold function with which, when it receives the second alarm information within the grace period after receiving the first alarm information, it sends the content of the second alarm information along with the first alarm information to the alerting device. When the server does not receive the second alarm information within the grace period after it has received the first alarm information, the server sends a message to indicate this condition to the alerting device. The server also has a transmission interrupt function that allows the user to stop transmission of the first alarm information by operating the control unit 1 within the set period.

In a favorable embodiment, at least the first alarm information is delivered to the user when the sensor detects that an abnormality has occurred. Thus, the user can reliably learn of at least the fact that an abnormality has occurred. The user can operate the control unit 1 within the set period to keep the second alarm information from being issued. By doing this, unnecessary alarm information, and more specifically, the image information from the surveillance camera 10, can be discarded.

Further, if the server receives the second alarm information within the grace period after it has received the first alarm information, then it sends the information of the second alarm information along with the first alarm information to the alerting device. When the server does not receive the second alarm information within the grace period, it sends a message to the alerting device to indicate this. Thus, in either case, the user learns that some manner of abnormality has occurred, even if the control unit 1 is destroyed after the first alarm information is issued.

The server also stops transmission of the first alarm information in response to an operation performed by the user through the control unit 1 within the set period. To put it differently, the first alarm information is transmitted if the user does not operate the control unit 1 within the set period. Thus, the user reliably learns of at least the fact that an abnormality has occurred, and by providing a server, it is possible to delete first alarm information that is not necessary to the user.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a perspective view of the control unit;

FIG. 2 is a schematic view of the security information notification system;

FIG. 3 is a flowchart showing the operation of the add delay mode;

FIG. 4 shows the screen of the portable telephone;

FIG. 5 is a schematic view of the security information notification system according to another embodiment;

FIG. 6 shows the relationship between the set period and the grace period;

FIG. 7 is a flowchart showing the normal operation;

FIG. 8 is a flowchart showing the operation when the control unit has been destroyed;

FIG. 9 is a flowchart showing the operation when the user has returned home; and

FIG. 10 is a schematic view of a conventional security information notification system.

### DETAILED DESCRIPTION OF PREFERRED EMBODIMENTS

### First Embodiment

An example of the present invention is described in greater detail below using the drawings.

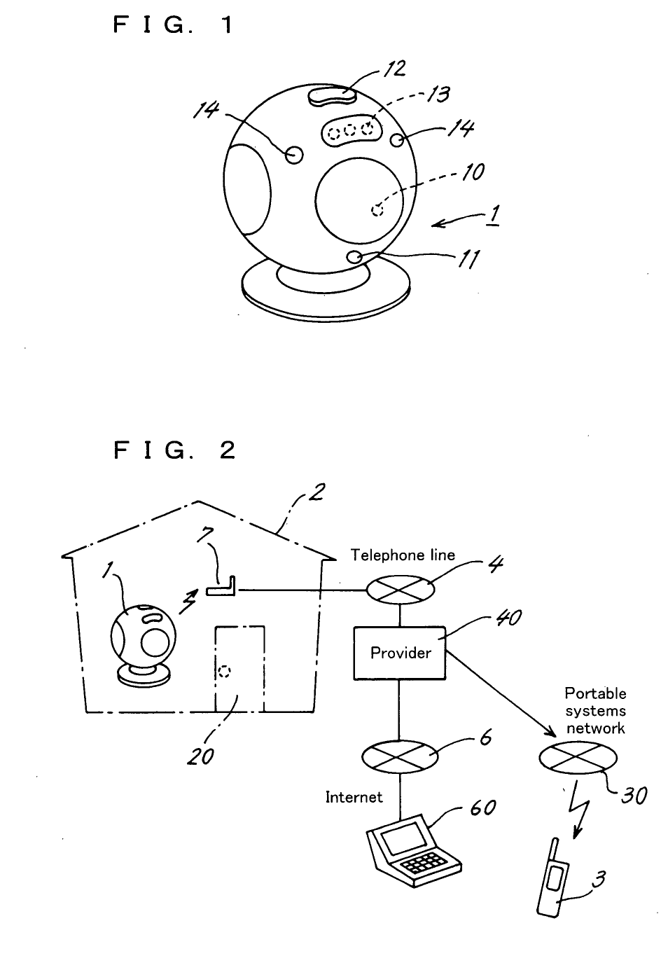

FIG. 1 is a perspective view of a control unit 1 that is employed in the security information notification system of this example. FIG. 2 is a schematic view of that security information notification system. The control unit 1 is internally provided with a surveillance camera 10 and a sensor 11, and the sensor 11 that for example detects the temperature changes found in humans and animals to sense that there is an intruder. The surveillance camera 10 is connected to an image processing circuit (not shown) within the control unit 1, and the image processing circuit detects movement from changes in images, which are data compressed in the JPEG (or MPEG) format. Naturally it is also possible for the sensor 11 to detect fire and gas leaks as well.

A remote control signal transmission portion 13 is provided on the front face of the control unit 1, and transmits infrared signals to an air conditioner or lighting fixture within the building. The user can employ a portable telephone 3, for example, to operate the air conditioner or lighting fixture from a remote location by causing the remote control signal transmission portion 13 to transmit infrared signals.

The control unit 1 has a “home/away” mode, and the home mode and the away mode can be toggled between by operating a switch button 12 that is provided on an upper portion of the control unit 1. The sensor 11 is not activated in home mode, and is activated in away mode. When the sensor 11 has detected an intruder, the control unit 1 sounds a buzzer, lights up or flashes auxiliary lights 14, and activates the abnormality notification function, which is discussed later.

The away mode includes the transmission delay mode discussed earlier and the add delay mode of this embodiment, and is characterized by this add delay mode. A video OUT terminal (not shown) is provided on the rear side of the control unit 1, and a menu screen can be displayed on a display via the video OUT terminal to allow the user to selectively set the transmission delay mode or the add delay mode. The menu screen also can be set from the personal computer 60 of FIG. 2. As will be discussed later, in the add delay mode a first electronic mail is transmitted and then, after an amount of time that has been set in advance has elapsed, a second electronic mail is produced and transmitted, and this set period t1 also can be input from the menu screen. The control unit 1 has a timer function and can measure the set period t1. For illustrative purposes this set period t1 has been put at one minute, but obviously is not limited to being one minute.

As shown in FIG. 2, the control unit 1 within the building 2 is connected to a router 7 wirelessly or through a wired connection, and the router 7 is connected to a provider 40 via a telephone line 4. The provider 40 is connected to a alerting device, and more specifically the portable telephone 3, that is in the possession of the user via a portable systems network 30, and also is connected to the Internet 6. Hereinafter, for the sake of convenience of description, the control unit 1 shall be placed near a door 20 of the building 2.

Add Delay Mode

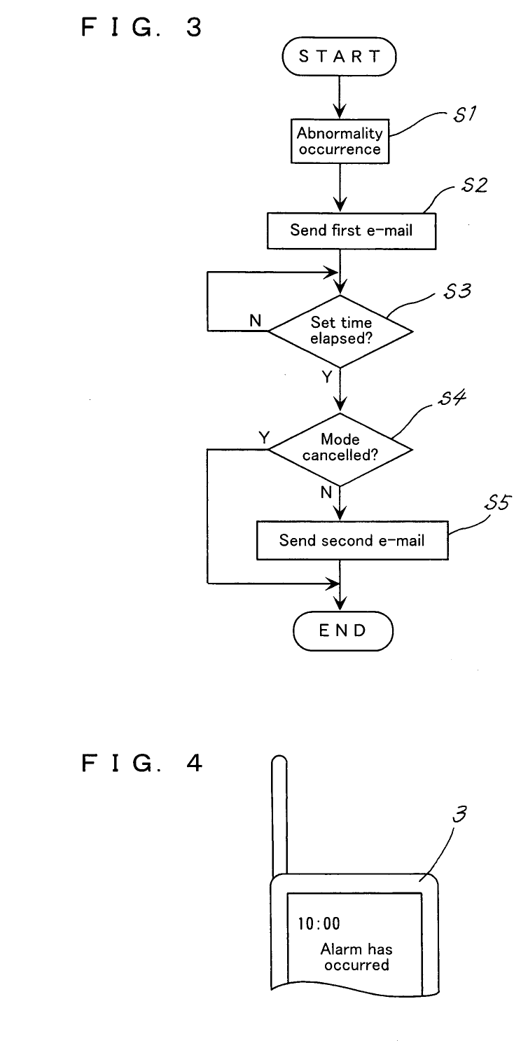

The operation when an intruder opens the door 20 at a time when the control unit 1 has been set to the add delay mode and the building 2 is empty is described using the flowchart of FIG. 3.

When it is detected that an abnormality has occurred, that is, the presence of an intruder has been detected, from the images continuously captured by the sensor 11 and the surveillance camera 10 (S1), the control unit 1 transmits a first electronic mail that indicates this condition to the portable telephone 3 (S2). As shown in FIG. 4, the first electronic mail is first alarm information in a text format that includes a notification that an abnormality has occurred and the time that the abnormality occurred, and is the first to arrive to the user. The first electronic mail also includes the set period t1 therein or as an attachment.

Next, the control unit 1 uses its timer function to measure the time elapsed since transmission of the first electronic mail. When one minute, which is the set period t1 (that is, the time set in advance by the user), has elapsed (S3), a second electronic mail that includes images that have been captured by the surveillance camera 10 or detailed information is produced and transmitted (S5). In this way, when there is an intruder, the user can learn that an abnormality has occurred within the building 2 from a remote location and can contact the police or a security company, for example.

When the control unit 1 detects that an abnormal situation has occurred, it transmits at least the first electronic mail to the user. Consequently, the user reliably learns of at least the fact that an abnormality has occurred.

If the user himself has returned home and opened the door 20, he does not need the second electronic mail. The user himself either operates the control unit 1 to turn off the add delay mode of the control unit 1 within the set period t1, or, by setting the mode to the home mode, the second electronic mail is not produced (S4). That is, the control unit 1 has a transmission interrupt function that allows the user to perform an operation within the set period t1 to stop production of the second electronic mail, which is the second alarm information. Thus, although the first electronic mail arrives, the unnecessary second electronic mail can be discarded. Discarding the unnecessary second electronic mail is particularly important because the second electronic mail includes image information and therefore is large is size.

It should be noted that because it takes time to capture images, it is also possible to produce the second electronic mail after finishing capturing images after the set period t1 has elapsed. It is also possible to send the first electronic mail and the second electronic mail to the user's personal computer 60 over the Internet 6.

### Second Embodiment

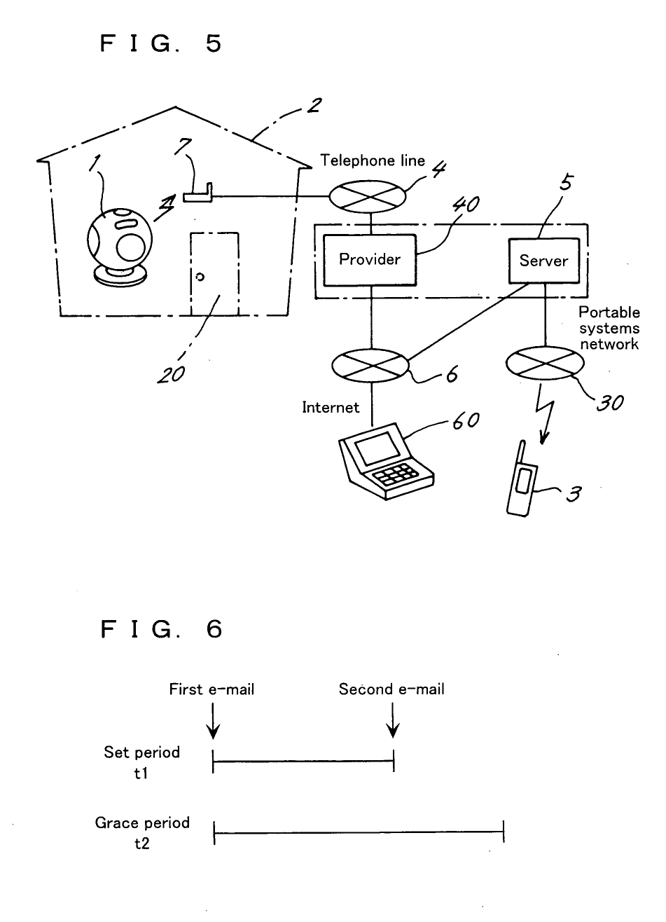

FIG. 5 is a schematic view of another security information notification system. A control unit 1 within a building 2 is connected to a router 7 wirelessly or through a wired connection, and the router 7 is connected to a provider 40 via a telephone line 4. The provider 40 is connected to a mail-dedicated server 5 via the Internet 6. The server 5 is connected to a portable telephone 3 that is in the possession of the user over a portable systems network 30. It should be noted that the provider 40 and the server 5 can be provided in a single unit as shown by the long-short dashed line.

The server 5 has a hold function of sending an electronic mail that it has received after holding it for a grace period t2. As shown in FIG. 6, the grace period t2 is a time that is greater than the set period t1 mentioned earlier. In this example, the server 5 holds the first electronic mail, and then sends the first electronic mail together with the second electronic mail that is generated after the set period t1 has elapsed, and thus a grace period t2 that is shorter than the set period t1 would not allow the server 5 to receive the second electronic mail. It is therefore necessary that the grace period t2 is at least as long as the set period t1, and for example, when the set period t1 is one minute the grace period t2 can be two minutes. Of course, as long as it is at least one minute, the grace period is not limited to two minutes.

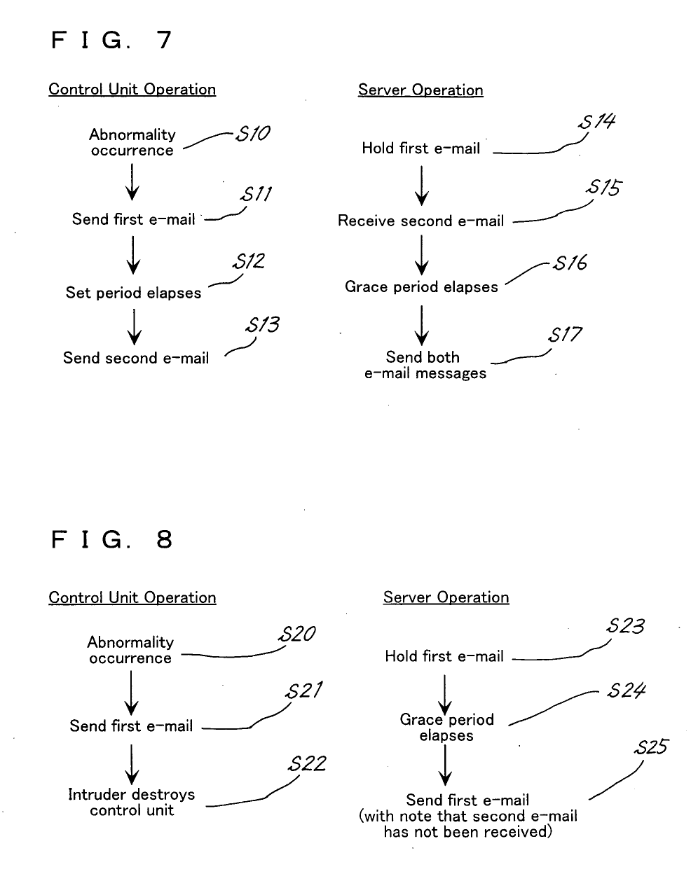

Normal Operation (FIG. 7)

The operation when an intruder opens the door 20 when the control unit 1 has been set to the add delay mode and the building 2 is empty is described using the chart of FIG. 7.

When the control unit 1 has detected that an abnormality has occurred, that is, the presence of an intruder, from the sensor 11 and the surveillance camera 10 images (S10), it transmits a first electronic mail indicating that condition to the portable telephone 3 (S11). Information on the grace period t2 (that is, a period at least a long as the set period t1) is attached to the first electronic mail. At this time, the server 5 holds the first electronic mail temporarily and does not immediately send it to the portable telephone 3 (S14).

When the set period t1 has elapsed since transmission of the first electronic mail (S12), the control unit 1 sends a second electronic mail, to which images or detailed information has been attached, to the server 5 (S13). After the grace period t2 has elapsed since it has received the first electronic mail, the server 5 sends the content of the second electronic mail together with the first electronic mail to the user (S15 to S17). The user thus can learn that an abnormality has occurred in the building 2 from a remote location.

When Control Unit is Destroyed (FIG. 8)

In the above scenario, it is conceivable that the intruder will become aware of the presence of the control unit 1, which is provided with the surveillance camera 10, and destroy (S22) the control unit 1 after the control unit 1 has issued the first electronic mail (S21) but before the set period t1 has elapsed. In this case, the second electronic mail is not sent to the server 5.

As shown in the chart of FIG. 8, if the server 5 does not receive the second electronic mail after it has received the first electronic mail and the grace period t2 has elapsed (S23, S24), then the server 5 attaches a message indicating that the second electronic mail was not received to the first electronic mail and sends it to the portable telephone 3 (S25). The user can understand from this that an abnormality has occurred in the building 2 and that some manner of problem has occurred in the control unit 1. Therefore, the user can learn that an abnormality of some manner has occurred in the building 2 even if the control unit 1 has been broken.

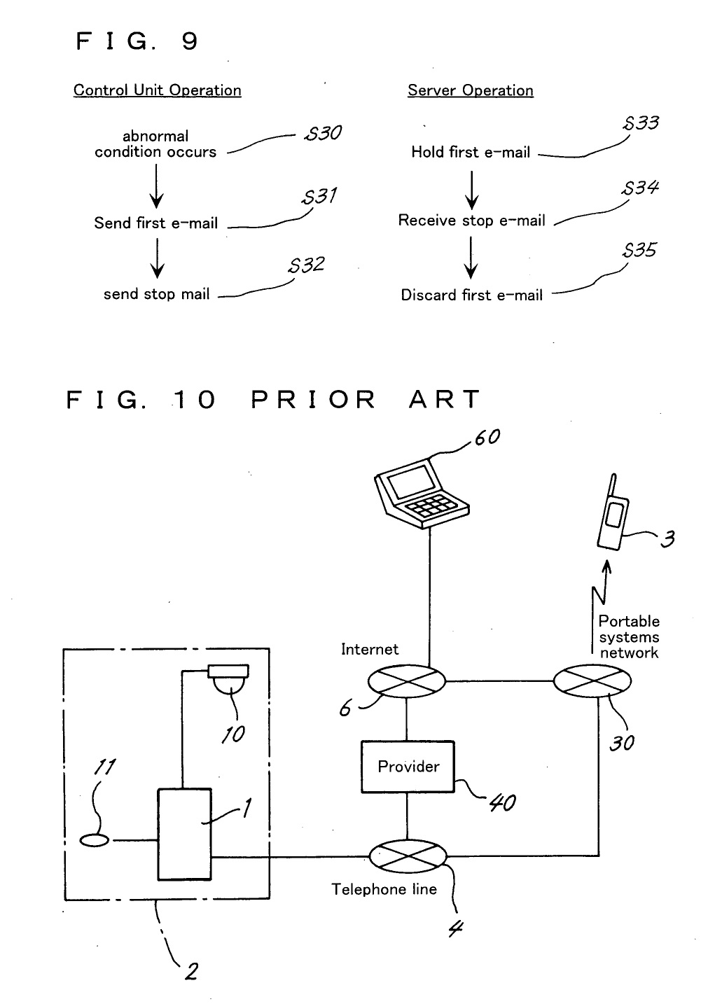

When User Returns Home (FIG. 9)

In the above case, when the user returns home and opens the door 20, the server 5 sends the first electronic mail to his portable telephone 3 (S31), and then after the grace period t2, it sends the second electronic mail. From the standpoint of the user, however, both e-mail messages are unnecessary and an annoyance.

In this case, as shown in the flowchart of FIG. 9, the user operates the control unit 1 within the set period t1 to send a stop mail to the server 5 from the control unit 1 (S32). This stop mail is sent from the control unit 1 by performing an operation that is simple yet difficult for anyone other than the user to know, such as pressing the switch button 12 two times consecutively, pushing and holding it down for several seconds, or pressing a hard-to-see button on the control unit 1 that is separate from the switch button 12.

When the server 5 receives the stop mail, it discards the first electronic mail that it is holding (S33 to S35). That is, the server 5 has a transmission interrupt function for allowing the user to operate the control unit 1 within the set period t1 to stop transmission of the first electronic mail. The second electronic mail is not sent from the control unit 1, and no electronic mail is received by the user from the server 5. By doing this, unnecessary electronic mail messages can be discarded, and thus the work to delete unnecessary electronic mail messages is obviated.

As mentioned above, it is also possible to send the first electronic mail and the second electronic mail to the user's personal computer 60 over the Internet 6.

This example has illustratively shown a portable telephone as the alerting device in the possession of the user, but it is also possible for this device to be installed in place rather than portable in nature. Further, electronic mail was adopted as the alarm information that is sent to the portable terminal, but it is also possible for at least the first electronic mail to be replaced by voice information. In the case of voice information, it is possible for the telephone line 4 and the portable systems network 30 in FIG. 2 to be connected directly. The portable terminal is not limited to the portable telephone 3, and also can be a PDA, for example.

Further, it is also possible that the control unit 1, the surveillance camera 10 and the sensor 11 are provided separately.

The control unit 1 also can receive signals input from alerting devices such as fire alarms, and security sensors that have been attached at positions other than the door 20, such as at windows. The first electronic mail includes information on the set period t1 in the above example, and together with this the first electronic mail also can include information from alerting devices or information from security sensors. Adding information from security sensors allows the location where the abnormality has occurred to be discerned. This makes it possible to gain a general idea of the location where the abnormality has occurred without receiving the second electronic mail, which is image information.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A security information notification system comprising:
a sensor for detecting abnormality occurrence; and
a control unit for receiving abnormality detection signal from the sensor, and issuing to a user first alarm information and, after a set period has elapsed since issuing the first alarm information, issuing second alarm information more detailed than the first alarm information; wherein
the control unit has a transmission interrupt function for, by user operation within the set period, stopping issuance of the second alarm information.

2. The security information notification system according to claim 1,
wherein the control unit is connected to a surveillance camera, and images from the surveillance camera are sent to the user over a network as the second alarm information.

3. A security information notification system comprising:
a sensor for detecting abnormality occurrence;
a control unit for receiving abnormality detection signal from the sensor, and issuing to a user first alarm information and, after a set period has elapsed since issuing the first alarm information, issuing second alarm information more detailed than the first alarm information; and
a server disposed between the control unit and an alerting device in the possession of the user, for holding the first alarm information for a grace period only.

4. The security information notification system according to claim 3,
wherein the server has a retaining function for, when having received the second alarm information within the grace period after receiving the first alarm information, sending to the alerting device the content of the second alarm information together with the first alarm information.

5. The security information notification system according to claim 3,
wherein when after having received the first alarm information the server does not receive the second alarm information within the grace period, the server sends to the alerting device a message to that effect.

6. The security information notification system according to claim 3,
wherein the server has a transmission interrupt function for, by user operation of the control unit within the set period, stopping transmission of the second alarm information

7. A security information notification method, for a system furnished with a sensor for detecting abnormality occurrence; a control unit for receiving an abnormality detection signal from the sensor, and issuing to a user first alarm information and, after issuing the first alarm information, issuing second alarm information more detailed than the first alarm information; and a server disposed between the control unit and an alerting device in the possession of the user, for holding the first alarm information for a grace period only, the method comprising:
a step of the server receiving and retaining the first alarm information; and
a step of, when having received the second alarm information within the grace period, sending to the alerting device the content of the second alarm information together with the first alarm information.

8. A security-information-notification system control unit, comprising:
a receiving unit for receiving abnormality detection signal from a sensor which detects abnormality occurrence;
a first issuing portion for issuing to a user first alarm information;
a second issuing portion for issuing second alarm information more detailed than the first alarm information; and
a first transmission interrupting portion for, by user operation within the set period, stopping issuance of the second alarm information.

9. A security-information-notification system control unit according to claim 8, further comprising:
a second transmission interrupting portion for, by user operation within the set period, stopping issuance of the first alarm information.
